(19) United States
(12) Patent Application Publication
(10) Pub. No.: US 2025/0336564 A1
(43) Pub. Date: Oct. 30, 2025

(54) COPPER-COATED STEEL WIRE

(71) Applicant: SUMITOMO ELECTRIC INDUSTRIES, LTD., Osaka-shi, Osaka (JP)

(72) Inventors: Kenta MATSUOKA, Osaka-shi (JP); Hiromu IZUMIDA, Osaka-shi (JP); Akihito HOSHIMA, Osaka-shi (JP)

(73) Assignee: SUMITOMO ELECTRIC INDUSTRIES, LTD., Osaka-shi, Osaka (JP)

(21) Appl. No.: 18/870,294

(22) PCT Filed: Jan. 16, 2023
(86) PCT No.: PCT/JP2023/000977

§ 371 Date: Nov. 27, 2024

(30) Foreign Application Priority Data
May 30, 2022 (JP) 2022-087545

(51) Int. Cl. H01B 5/02

(52) U.S. Cl. CPC H01B 5/02

(57) ABSTRACT

A copper-coated steel wire includes a core wire made of an austenitic stainless steel, a first coating layer made of Ni covering an outer peripheral surface of the core wire, and a second coating layer made of copper or a copper alloy covering an outer peripheral surface of the first coating layer. The core wire includes an austenite layer arranged to constitute the outer peripheral surface and having a thickness of not less than 1 μm and not more than 10 μm and a volume ratio of an austenitic structure of not less than 80%, and a martensite layer arranged on an inner peripheral side of the austenite layer and having a volume ratio of a martensitic structure of not less than 80%.

### TECHNICAL FIELD

The present disclosure relates to a copper-coated steel wire.

The present application claims priority based on Japanese Patent Application No. 2022-87545 filed on May 30, 2022, the entire contents of which are incorporated herein by reference.

### BACKGROUND ART

In the case where both strength and conductivity are required in electric wires, copper-coated steel wires including a core wire made of a steel and a coating layer made of copper (Cu) or a copper alloy may be adopted (see, for example, Japanese Patent Application Laid-Open No. H01-289021 (Patent Literature 1), Japanese Patent Application Laid-Open No. 2002-270039 (Patent Literature 2), and Japanese Patent Application Laid-Open No. 2020-021620 (Patent Literature 3)). The core wire made of a steel contributes to increased strength, and the coating layer made of copper or a copper alloy provides high conductivity.

### CITATION LIST

### Patent Literature

Patent Literature 1: Japanese Patent Application Laid-Open No. H01-289021
Patent Literature 2: Japanese Patent Application Laid-Open No. 2002-270039
Patent Literature 3: Japanese Patent Application Laid-Open No. 2020-021620

### SUMMARY OF INVENTION

A copper-coated steel wire according to the present disclosure includes: a core wire made of an austenitic stainless steel; a first coating layer made of Ni covering an outer peripheral surface of the core wire; and a second coating layer made of copper or a copper alloy covering an outer peripheral surface of the first coating layer. The core wire includes an austenite layer arranged to constitute the outer peripheral surface and having a thickness of not less than 1 μm and not more than 10 μm and a volume ratio of an austenitic structure of not less than 80%, and a martensite layer arranged on an inner peripheral side of the austenite layer and having a volume ratio of a martensitic structure of not less than 80%.

### BRIEF DESCRIPTION OF DRAWINGS

FIG. 1 is a schematic view of the structure of a copper-coated steel wire.

FIG. 2 is a schematic cross-sectional view of the structure of the copper-coated steel wire.

FIG. 3 is a flowchart illustrating the outline of a method of producing a copper-coated steel wire.

FIG. 4 is a photograph showing an example of a cross section of a sample in which separation did not occur in a compression test.

FIG. 5 is a photograph showing an example of a cross section of a sample in which separation occurred in the compression test.

### DESCRIPTION OF EMBODIMENTS

### Problems to be Solved by Present Disclosure

The copper-coated steel wire described above may require corrosion resistance in some operating environments. In such a case, an austenitic stainless steel with excellent corrosion resistance can be adopted as the steel constituting the core wire. At this time, a first coating layer made of nickel (Ni) is formed on a surface of the core wire, and a second coating layer made of copper or a copper alloy is formed on the first coating layer. The surface of the core wire made of the austenitic stainless steel is covered with a passivation film. Therefore, if a coating layer made of copper or a copper alloy is formed directly on the surface of the core wire, sufficient adhesion between the core wire and the coating layer cannot be obtained. Adopting the first coating layer made of nickel, which can adhere to both the core wire made of an austenitic stainless steel and the second coating layer made of copper or a copper alloy, can suppress the separation of the coating layer from the core wire.

However, even if the above-described first coating layer made of nickel is adopted, there may occur separation between the core wire and the coating layer when the copper-coated steel wire is crimped at a crimp terminal. Connection to a crimp terminal is important for the copper-coated steel wire as a simple connection method. The occurrence of separation of the coating layer may result in reduced strength at the connected portion to a crimp terminal, crevice corrosion of the core wire, and the like.

Therefore, one of the objects of the present disclosure is to provide a copper-coated steel wire having corrosion resistance and capable of achieving both strength and conductivity, and also capable of suppressing separation of the coating layer at the time of connection to a crimp terminal.

### Advantageous Effects of Present Disclosure

According to the copper-coated steel wire described above, it is possible to provide a copper-coated steel wire that has corrosion resistance and achieves both strength and conductivity, and also suppresses separation of the coating layer at the time of connection to a crimp terminal.

### DESCRIPTION OF EMBODIMENTS OF PRESENT DISCLOSURE

Embodiments of the present disclosure will first be listed and described. A copper-coated steel wire of the present disclosure includes: a core wire made of an austenitic stainless steel; a first coating layer made of Ni covering an outer peripheral surface of the core wire; and a second coating layer made of copper or a copper alloy covering an outer peripheral surface of the first coating layer. The core wire includes an austenite layer arranged to constitute the outer peripheral surface and having a thickness of not less than 1 μm and not more than 10 μm and a volume ratio of an austenitic structure of not less than 80%, and a martensite layer arranged on an inner peripheral side of the austenite layer and having a volume ratio of a martensitic structure of not less than 80%.

The present inventors investigated measures to suppress the separation of the coating layer at the time of connection to a crimp terminal. As a result, they found that the separation of the coating layer can be suppressed by making the surface layer portion of the core wire, which generally has a microstructure consisting mainly of a martensitic structure (strain induced martensitic structure) due to a wire drawing process, have a microstructure consisting mainly of an austenitic structure. This is conceivably for the following reasons. In general, the surface layer portion of the core wire has a microstructure consisting mainly of a strain induced martensitic structure due to a wire drawing process. The strain induced martensitic structure has a crystal structure of body-centered tetragonal lattice with a lattice constant of 0.284 nm to 0.296 nm (2.84 Å to 2.96 Å). In contrast, Ni constituting the first coating layer has a crystal structure of face-centered cubic lattice with a lattice constant of 0.352 nm (3.52 Å). The above fact that the surface layer portion of the core wire and the first coating layer have different crystal structures with a large difference in lattice constant is considered to be the reason for the separation of the coating layer at the time of connection to a crimp terminal. On the other hand, an austenitic structure has a crystal structure of face-centered cubic lattice with a lattice constant of 0.364 nm (3.64 Å). By making the surface layer portion of the core wire have a microstructure consisting mainly of an austenitic structure, the crystal structure of the surface layer portion of the core wire and that of the first coating layer can be matched and the difference in lattice constant between them can be reduced, thereby suppressing separation of the coating layer at the time of connection to a crimp terminal.

In the copper-coated steel wire of the present disclosure, the austenitic stainless steel adopted as the steel constituting the core wire ensures excellent corrosion resistance. In addition, the core wire made of a steel, in particular a martensite layer of high strength, contributes to increased strength. Moreover, the second coating layer made of copper or a copper alloy provides high conductivity. Then, the austenite layer having a thickness of not less than 1 μm and not more than 10 μm and in which the volume ratio of the austenitic structure is not less than 80% is arranged so as to constitute the outer peripheral surface of the core wire. This suppresses separation of the coating layer at the time of connection to a crimp terminal. As such, the copper-coated steel wire of the present disclosure has corrosion resistance and achieves both strength and conductivity, and also suppresses separation of the coating layer at the time of connection to a crimp terminal.

In the above copper-coated steel wire, the core wire may have an outside diameter of not less than 0.05 mm and not more than 1 mm. If the outside diameter of the core wire is less than 0.05 mm, the ratio of the austenite layer in the core wire becomes large. This makes it difficult to ensure sufficient strength. If the outside diameter of the core wire exceeds 1 mm, it becomes difficult to set the production conditions causing the austenite layer to have a thickness of not less than 1 μm and not more than 10 μm. Setting the outside diameter of the core wire to 0.05 mm or more and 1 mm or less facilitates the production of the above-described copper-coated steel wire having sufficient strength. As used herein, the “wire diameter” means the diameter of a circle in the case where the cross section perpendicular to the longitudinal direction is circular. In the case where the cross section is not circular, the wire diameter means the diameter of a circle circumscribing the cross section.

In the above copper-coated steel wire, the first coating layer may have a thickness of not less than 0.001 μm and not more than 50 μm. By setting the thickness of the first coating layer to 0.001 μm or more, the adhesion to the second coating layer can be obtained more reliably. On the other hand, even if the thickness of the first coating layer is increased to more than 50 μm, the effect will be saturated. Therefore, the thickness of the first coating layer is preferably 50 μm or less, and may be 30 μm or less. From the standpoint of achieving more reliable adhesion to the second coating layer, the thickness of the first coating layer is preferably 0.015 μm or more.

The above copper-coated steel wire may have a tensile strength of not less than 600 MPa and not more than 2500 MPa. Setting the tensile strength to 600 MPa or more facilitates obtaining sufficient strength as a copper-coated steel wire, particularly as a copper-coated steel wire used as an electric wire. Setting the tensile strength to 2500 MPa or less facilitates ensuring sufficient toughness. The tensile strength of the above copper-coated steel wire is preferably 900 MPa or more. The tensile strength of the above copper-coated steel wire is preferably 2200 MPa or less.

The above copper-coated steel wire may have an electrical conductivity of not less than 20% IACS and not more than 80% IACS. This makes it easier to obtain a copper-coated steel wire particularly suitable for use as an electric wire.

In the above copper-coated steel wire, the austenitic stainless steel constituting the core wire may be JIS standard SUS301 (SUS301-CSP), SUS304, or SUS316. From the standpoint of strength, corrosion resistance, and the like, SUS301, SUS304, and SUS316 are suitable as the material constituting the core wire. As used herein, the austenitic stainless steel refers to steels having component compositions as specified in JIS G4308 and JIS G4313 of the JIS standard (Japan Industrial Standard).

### DETAILS OF EMBODIMENTS OF PRESENT DISCLOSURE

An embodiment of the copper-coated steel wire according to the present disclosure will be described below with reference to the drawings. In the drawings referenced below, the same or corresponding portions are denoted by the same reference numerals and the description thereof will not be repeated.

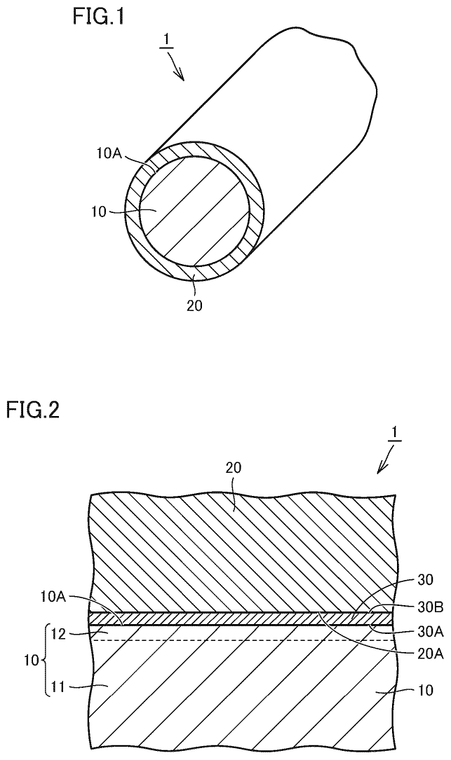

FIG. 1 is a schematic view of the structure of a copper-coated steel wire. FIG. 2 is a schematic cross-sectional view of the structure of the copper-coated steel wire. FIG. 2 is a cross-sectional view in a plane perpendicular to the longitudinal direction of the copper-coated steel wire, showing the area around a first coating layer in an enlarged view.

Referring to FIGS. 1 and 2, the copper-coated steel wire 1 in the present embodiment includes a core wire 10, a first coating layer 30, and a second coating layer 20. The copper-coated steel wire 1 has a circular cross section perpendicular to the longitudinal direction thereof. The core wire 10 is made of an austenitic stainless steel. For the austenitic stainless steel constituting the core wire 10, SUS301, SUS304, or SUS316, for example, may be adopted. The core wire 10 may have an outside diameter of, for example, not less than 0.05 mm and not more than 1 mm. The core wire 10 has a circular cross section perpendicular to the longitudinal direction thereof.

The first coating layer 30 is arranged to cover an outer peripheral surface 10A of the core wire 10 over the entire area. The first coating layer 30 is in contact with the outer peripheral surface 10A of the core wire 10 at its inner peripheral surface 30A. The first coating layer 30 is formed of Ni. The first coating layer 30 may have a thickness of, for example, not less than 0.001 μm and not more than 50 μm. The first coating layer 30 may be, for example, a plated layer formed by plating. In the present embodiment, the first coating layer 30 is composed of pure Ni (composed of Ni and unavoidable impurities).

The second coating layer 20 is arranged to cover an outer peripheral surface 30B of the first coating layer 30 over the entire area. The second coating layer 20 is in contact with the outer peripheral surface 30B of the first coating layer 30 at its inner peripheral surface 20A. The second coating layer 20 is formed of Cu or a Cu alloy. The second coating layer 20 may have a thickness of, for example, not less than 5 μm and not more than 150 μm. The second coating layer 20 may be, for example, a plated layer formed by plating. The second coating layer 20 may be a Cu plated layer. That is, the second coating layer 20 may be composed of pure copper (composed of copper and unavoidable impurities). In the present embodiment, the second coating layer 20 constitutes a surface (outer peripheral surface) of the copper-coated steel wire 1. In another embodiment, a surface layer composed of at least one metal selected from the group consisting of gold, silver, tin, palladium, and nickel may be formed to constitute the surface (outer peripheral surface) of the copper-coated steel wire 1.

Referring to FIG. 2, the core wire 10 includes an austenite layer 12 and a martensite layer 11. The austenite layer 12 is arranged to constitute the outer peripheral surface 10A of the core wire 10. The outer peripheral surface 10A of the core wire 10 is configured with the austenite layer 12 over the entire area. The austenite layer 12 is a layer in which the volume ratio of an austenitic structure is 80% or more. The austenite layer 12 has a thickness of not less than 1 μm and not more than 10 μm.

The martensite layer 11 is arranged on an inner peripheral side of the austenite layer 12. The martensite layer 11 is a layer in which the volume ratio of a martensitic structure is 80% or more. Between the martensite layer 11 and the austenite layer 12, an intermediate layer may be formed in which the volume ratio of the martensitic structure and the volume ratio of the austenitic structure are both less than 80 vol %. In the present embodiment, the martensite layer 11 constitutes the entirety of the inner peripheral side of the austenite layer 12 (or the inner peripheral side of the intermediate layer). The martensite layer 11 constitutes a core of the core wire 10. The martensite layer 11 preferably occupies 80 vol % or more of the core wire 10. It should be noted that the presence of the martensite layer 11 and the austenite layer 12 can be confirmed, for example, by a peak corresponding to the austenitic structure and a peak corresponding to the martensitic structure obtained by performing X-ray diffraction analysis on a cross section perpendicular to the longitudinal direction of the core wire 10.

In the copper-coated steel wire 1 of the present embodiment, excellent corrosion resistance is ensured by adopting the austenitic stainless steel as the steel constituting the core wire 10. Further, the core wire 10 made of a steel, in particular the martensite layer 11 of high strength, contributes to increased strength. Furthermore, the second coating layer 20 made of copper or a copper alloy provides high conductivity. Then, the austenite layer 12 is arranged to constitute the outer peripheral surface 10A of the core wire 10. This suppresses separation of the coating layers 20, 30 at the time of connection to a crimp terminal. As such, the copper-coated steel wire 1 of the present embodiment is a copper-coated steel wire that has corrosion resistance and achieves both strength and conductivity, and also suppresses separation of the coating layer at the time of connection to a crimp terminal.

The tensile strength of the copper-coated steel wire 1 is preferably not less than 600 MPa and not more than 2500 MPa. Setting the tensile strength to 600 MPa or more facilitates obtaining sufficient strength as a copper-coated steel wire, particularly as a copper-coated steel wire used as an electric wire. Setting the tensile strength to 2500 MPa or less facilitates ensuring sufficient toughness.

The electrical conductivity of the copper-coated steel wire 1 is preferably not less than 20% IACS and not more than 80% IACS. With this, the copper-coated steel wire 1 becomes a wire particularly suitable for use as an electric wire.

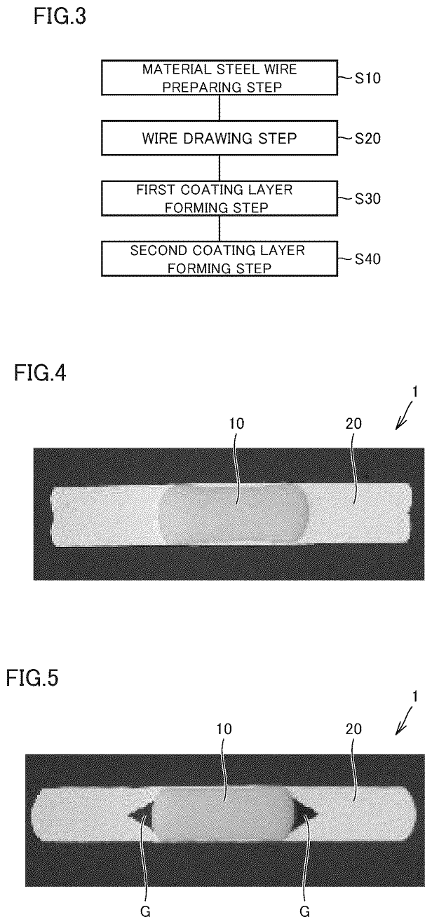

An example of the method of producing the copper-coated steel wire 1 will now be described mainly on the basis of FIG. 3. Referring to FIG. 3, in the method of producing the copper-coated steel wire 1 of the present embodiment, first, a material steel wire preparing step is performed as step S10. In this step S10, a material steel wire to be the core wire 10 is prepared. Specifically, a steel wire having a component composition corresponding to JIS standard SUS301, SUS304, or SUS316, for example, is prepared. The outside diameter of the material steel wire may be, for example, not less than 0.1 mm and not more than 2 mm.

Next, a wire drawing step is performed as step S20. In this step S20, the material steel wire prepared in step S10 is subjected to a wire drawing process (drawing process). The wire drawing process in step S20 may be performed at a degree of working (reduction of area) of, for example, not less than 90% and not more than 98%. The wire drawing process may be performed by dividing it into a plurality of times.

In this step S20, a martensite layer 11 and an austenite layer 12 are formed. The material steel wire prepared in step S10 has a microstructure consisting mainly of an austenitic structure over the entire area. By setting the reduction of area in step S20 to a high value as described above, the region including the core portion becomes the martensite layer 11. On the other hand, to form the austenite layer 12, it is necessary to set the surface of the material steel wire at a temperature higher than usual, specifically 200° C. or higher, in step S20 to suppress the strain induced martensitic transformation in the surface layer portion. In order to set the surface of the material steel wire at 200° C. or higher, the work conditions may be adjusted, for example, as follows: increasing the reduction of area per one time in the case of performing the wire drawing process by dividing it into a plurality of times; increasing the die half angle of a die used for wire drawing within a workable range; increasing the wire drawing speed within a workable range; and the like. The surface temperature of the material steel wire may also be adjusted using a separately prepared heating means. The core wire 10 including the martensite layer 11 and the austenite layer 12 can be obtained by performing the step S20 in the above-described manner.

Next, a first coating layer forming step is performed as step S30. In this step S30, a first coating layer 30 made of Ni is formed to cover the surface of the core wire 10 obtained in step S20. Specifically, the first coating layer 30 having a desired thickness can be formed by Ni strike plating, for example.

Next, a second coating layer forming step is performed as step S40. In this step S40, a second coating layer 20 made of Cu or a Cu alloy is formed to cover the surface of the first coating layer 30 formed in step S30. Specifically, Cu plating, for example, can be performed to form the second coating layer 20 having a desired thickness. The copper-coated steel wire 1 of the present embodiment can be easily produced through the above-described procedure.

### EXAMPLES

An experiment was conducted to check the occurrence of separation of the coating layer in the copper-coated steel wire of the present disclosure when a process assuming connection to a crimp terminal was performed. The experimental procedure was as follows.

First, the copper-coated steel wire 1 was fabricated using the same procedure as in the above embodiment. For the material steel wire, a steel wire made of JIS standard SUS304 was prepared. For the second coating layer 20, a pure Cu layer was formed by plating. A plurality of samples were fabricated by varying the outside diameter of the core wire 10 and the thickness of the second coating layer 20 (Inventive Examples). On the other hand, the conditions in the wire drawing process in step S20 were changed to form samples that did not include the austenite layer 12 with the volume ratio of the austenitic structure of 80% or more (Comparative Examples). For each sample, electrical conductivity, tensile strength, and the ratio of the austenitic structure at a depth of 5 μm from the outer peripheral surface 10A of the core wire 10 were checked, and a compression test was also performed on the copper-coated steel wire 1. The compression test was conducted under the conditions that the copper-coated steel wire 1 was compressed in the radial direction and the load was released at the time when the height became 40% of the original outside diameter. The presence/absence of separation of the coating layers 30, 20 after the compression test was observed.

FIG. 4 is a photograph of an example of the cross section of a sample in which separation did not occur in the compression test. FIG. 5 is a photograph of an example of the cross section of a sample in which separation occurred in the compression test. Referring to FIGS. 4 and 5, it was judged that separation was not observed when no gap G was formed between the core wire 10 and the second coating layer 20 as shown in FIG. 4, and that separation was observed when a gap G was formed as shown in FIG. 5. The experimental conditions and results are shown in Table 1.

TABLE 1

| | | | | Ratio of Austenitic | |
|---|---|---|---|---|---|
| | | Electrical | | Structure at Depth | |
| | Wire | Conduc- | Tensile | of 5 μm from Outer | |
| | Diameter | tivity | Strength | Peripheral Surface | |
| | (mm) | (% IACS) | (MPa) | (vol %) | Separation |
| A | 0.2 | 60 | 1160 | 80 | Not observed |
| B | 0.2 | 60 | 1160 | 95 | Not observed |
| C | 0.2 | 40 | 1540 | 80 | Not observed |
| D | 0.5 | 60 | 1160 | 80 | Not observed |
| E | 0.5 | 60 | 1160 | 95 | Not observed |
| F | 0.5 | 40 | 1540 | 80 | Not observed |
| G | 0.8 | 60 | 1160 | 80 | Not observed |
| H | 0.8 | 60 | 1160 | 95 | Not observed |
| I | 0.8 | 40 | 1540 | 80 | Not observed |
| J | 0.2 | 60 | 1160 | 0 | Observed |
| K | 0.5 | 60 | 1160 | 40 | Observed |
| L | 0.8 | 40 | 1540 | 70 | Observed |

Referring to Table 1, Samples A through I correspond to the inventive examples of the present disclosure, and Samples J through L correspond to the comparative examples failing to satisfy the conditions of the present disclosure. For the electrical conductivity, it was confirmed that the values depend on the area ratio of the second coating layer 20 in the cross section perpendicular to the longitudinal direction of the copper-coated steel wire 1, since the second coating layer 20 made of pure Cu is responsible for the conductivity. For the tensile strength, it was confirmed that the values depend on the outside diameter of the core wire 10, since the core wire 10 is responsible for the tensile strength. While separation occurred in the compression test in Samples J through L in which the core wire 10 did not have an austenite layer 12, separation did not occur in Samples A through I in which the core wire 10 had the austenite layer 12, regardless of the wire diameter, electrical conductivity, and tensile strength. The above has confirmed that the copper-coated steel wire of the present disclosure is capable of suppressing separation of the coating layer at the time of connection to a crimp terminal due to the core wire 10 having the austenite layer 12.

It should be understood that the embodiment and the examples disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1: copper-coated steel wire; 10: core wire; 10A: outer peripheral surface; 11: martensite layer; 12: austenite layer; 20: second coating layer; 20A: inner peripheral surface; 30: first coating layer; 30A: inner peripheral surface; 30B: outer peripheral surface; and G: gap.

1. A copper-coated steel wire comprising:
a core wire made of an austenitic stainless steel;
a first coating layer made of Ni covering an outer peripheral surface of the core wire; and
a second coating layer made of copper or a copper alloy covering an outer peripheral surface of the first coating layer;
the core wire including
an austenite layer arranged to constitute the outer peripheral surface and having a thickness of not less than 1 μm and not more than 10 μm and a volume ratio of an austenitic structure of not less than 80%, and
a martensite layer arranged on an inner peripheral side of the austenite layer and having a volume ratio of a martensitic structure of not less than 80%.

2. The copper-coated steel wire according to claim 1, wherein the core wire has an outside diameter of not less than 0.05 mm and not more than 1 mm.

3. The copper-coated steel wire according to claim 1, wherein the first coating layer has a thickness of not less than 0.001 μm and not more than 50 μm.

4. The copper-coated steel wire according to claim 1, having a tensile strength of not less than 600 MPa and not more than 2500 MPa.

5. The copper-coated steel wire according to claim 1, having an electrical conductivity of not less than 20% IACS and not more than 80% IACS.

6. The copper-coated steel wire according to claim 1, wherein the austenitic stainless steel constituting the core wire is JIS standard SUS301, SUS304, or SUS316.
